(19) United States
(12) Patent Application Publication
(10) Pub. No.: US 2004/0003525 A1
(43) Pub. Date: Jan. 8, 2004

(54) Pin board with changeable images

(76) Inventors: Jafar Daryabagi, Rolling Hills Estates, CA (US); Sam Saeed Shariat, Rolling Hills Estates, CA (US)

Correspondence Address: Terrell P. Lewis, 343 Palos Verdes Blvd., Unit #8, Redondo Beach, CA, 90277, US

(21) Appl. No.: 10/188,787

(22) Filed: Jul. 3, 2002

(51) Int. Cl. G09F 7/00

(52) U.S. Cl. 40/584

(57) ABSTRACT

A board assembly for supporting memos and the like by the use of pins or other impaling implements includes a multi-layer substrate having at least a first supporting layer and a second layer on which an image is formed on a top surface thereof, the second layer being adapted to be mounted to the supporting layer, a frame for displaying the image carried by the top surface of the second layer of the substrate, and at least one other layer, exhibiting a second image different from the first image, adapted to be mounted atop the first layer of the substrate for selectively changing the image visible to a viewer. The second layer comprises woven or non-woven polyester material, and the image formed on the second layer is formed using a sublimation printing process.

### BACKGROUND OF THE INVENTION

1. Field of the Invention

The present invention relates to boards used for posting or attaching memos and the like, and more particularly to pin, memo, and cork boards on which images are displayed atop the surface to which the memos and other similar reminder devices are attached. Even more particularly, the present invention relates to a multilayer board assembly having a first support layer which can retain sharp pointed objects, such as pins, darts or nails, a second layer bearing an image that can be changed or replaced, and at least one third layer bearing an image different from the image on the second layer that can be placed over the second layer, used in place of the second layer, or secured to the surface of the first layer opposite to the surface to which the second layer is mounted. A frame can be provided with the board assembly, and a kit can be assembled which includes the board assembly, a frame if desired, and one or more of the third layers.

2. Description of the Related Art

Memo and game boards have been long known and used, and can take the form of a layer of cork, pressed particulate material, or soft wood mounted on a firm or hard layer of wood or metal. Pin boards, like their kin cork boards, are boards to which notes and memos can be attached by impaling the notes and memos on pins or other sharp pointed implements and driving them point first into the board surfaces where they are retained until removal.

Typically, the boards are painted for decoration, or covered with a colored or metallized layer, such as a film or foil, so that holes made when the pins or implements are inserted and removed from the board surfaces will not be readily visible.

Frames for retention of pictures and other forms of display are also well-known and have been found in the commercial marketplace for many years. Many picture frames, as we know them today, include four elongated frame side members, each of which is typically formed with a channel for receiving and securing together, in a stacked relationship, the layers of a picture assembly which might include an image-bearing layer, such as the picture itself, matting material, a sturdy backing sheet to impart rigidity to the picture, and a layer of glass or plastic. Preferably, adjacent side members are mounted normal to each other, with the channels being positioned on the same side of the frame side memebers. The picture assembly is generally retained in the channels of the frame side members.

The present invention provides a versatile and fun alternative to the traditional memo board or pin board by securing an image bearing layer to at least one surface of a board, and by also providing, when desired, at least one alternate image-bearing layer which can be used atop or substituted for the image-bearing layer provided with the boards, or used on another surface of the board.

### SUMMARY OF THE INVENTION

In one aspect of the present invention, a pin board assembly according to the present invention includes a multilayer substrate having a first layer with a puncturable surface adapted to receive and secure stickpins, or other fastening devices having pointed ends, for posting memos, notes or other reminder devices to the puncturable surface of the first support layer, a second layer bearing an image and adapted to cover the puncturable surface of the first support layer to make the puncturable surface aesthetically pleasing to the human eye, and at least one other layer bearing an image different from the image of the second layer.

Another aspect of the invention entails using one of the other image-bearing layers on a surface of the board opposite to the surface on which a first image-bearing layer is mounted.

In another aspect of the invention, the picture assembly includes images that preferably have been formed using a sublimation printing process.

Another aspect of the invention entails a kit comprising a multilayer substrate including a first support layer into which pins or other similar fasteners are able o be releasably retained and a second image-bearing layer, and further including one or more image-bearing third layers wherein each of the third layers bears an image different from the image exhibited by the second image-bearing layer.

Still another aspect of the invention encompasses a kit comprising a multilayer substrate including a first support layer into which pins or other similar fasteners are to be releasably retained and a second image-bearing layer, one or more image-bearing third layers where each of the third layers bears an image different from the image exhibited by the second image-bearing layer, and a frame for holding the substrate and image-bearing layer.

These and other aspects, advantages and features of the invention will become more apparent, as will equivalent structures which are intended to be covered herein, with the teaching of the principles of the invention in connection with the disclosure of the preferred embodiments thereof in the specification, claims and drawings in which:

### BRIEF DESCRIPTION OF THE DRAWINGS

FIG. 1 is a perspective view of a representative embodiment of the board assembly of the present invention; and

FIG. 2 shows a cross-section of the board assembly of FIG. 1 in a frame.

### DETAILED DESCRIPTION OF THE INVENTION

The following description is provided to enable any person skilled in the art to make and use the invention and sets forth the best modes contemplated by the inventor of carrying out this invention. Various modifications, however, will become readily apparent to those skilled in the art since the generic principles of this invention have been defined herein specifically to provide a pin board structure which can be used alone or with several image-bearing layers.

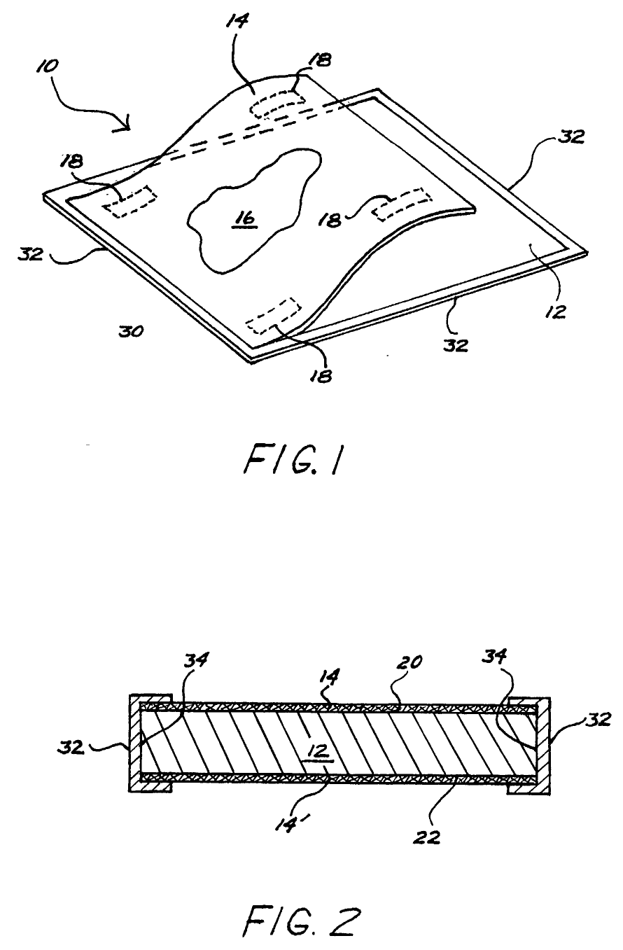

Referring now to FIGS. 1 and 2 of the drawing, the board assembly 10 of the present invention is shown to include a first support layer 12 having opposing major surfaces and a second layer 14 having an image 16 on one surface thereof. The second layer 14 is mounted to the first layer 12 in such a manner that the image 16 is facing away from the first layer, and visible to a viewer.

Preferably, the first support layer 12 comprises a rigid sheet of material, such as wood, wood material, or compressed particlulate material. A sheet of cork or other similar material into which a pin or similar implement can be releasably retained may also be adhered to one or both of the opposing major surfaces on one or both of the outer surfaces of the first layer. The second layer 14 is secured over the first layer 12 and comprises a layer of woven or non-woven polyester or similar material suitable for receipt of an image applied through a sublimation printing process. The image formed on the second layer 14 can be any image that can be formed using the sublimation printing process.

Preferably, the second layer 14 is secured to the first support layer 12 via adhesive provided on the surface of layer 12 against which the second layer 14 is to be disposed, preferably in areas or patterns 18 which cover all or at least a substantial part of the surface which the second layer 14 covers.

FIG. 2 is a cross-sectional view of the board assembly of the present invention shown in FIG. 1. The image-bearing second layer 14 is shown disposed on and mounted to one side surface 20 of the first support layer 12. Also shown is a second image-bearing layer 14′ mounted to an opposite side 22 of the first support layer 12. Preferably, either second layer 14 or 14′ can be mounted to the respective surface of the first layer to which it is mounted using adhesive 18, in the manner described above.

The frame assembly 30 preferably comprises four side elements 32 that are disposed about the edges of the multi-layer board assembly 10 in which each of the side elements includes a channel 34 (note that in FIG. 2, only the channels in side elements 32 arranged in opposition to one another are shown). Channels of adjacent side elements 32 are arranged at right angles to each other in such a manner that an edge portion of the board assembly 10 is retained within the channels, and hence within the frame assembly.

In using the board assembly 10 of the present invention, image-bearing second layers 14 could be mounted atop one or both of the opposing surfaces of the support layer 12 before insertion of the assembled board assembly 10 in the frame assembly.

Where only one second layer is incorporated into the board assembly, when It is desired, or whenever it is determined to be necessary, to change the image-bearing second layer 14, the board assembly 10 can be removed from the frame assembly and the second layer to be changed can be stripped from the first support layer and a new second layer can be applied to, i.e., atop, the first layer. Alternatively, the new second layer to be applied can be applied directly over the original second layer, and adhered to the original second layer by pressing the adhesive areas carried by the new second layer against the outer surface of the original second layer. It is also contemplated that the board assembly 10 may be turned over so that another second layer, already installed in the board assembly 10 on the surface 22 opposite the first surface 20, can be rendered visible and usable.

The invention further contemplates providing the board assembly and one or more additional image-bearing second layers in a container as a kit, with or without the inclusion of a frame. Further, the board assembly may be offered for sale to the consuming public, along side additional second layers, packaged separately or in groups, and along side frame assemblies, so that the consuming public can obtain as many additional image-bearing second layers as desired, and can also place the board assembly in a frame, if desired.

Those skilled in the art will appreciate that various adoptions and modifications of the invention as described above can be configured without departing from the scope and spirit of the invention. Therefore, it is to be understood that, within the scope of the appended claims, the invention may be practiced other than as specifically described herein.

What I claim is:

1. A pin board kit, comprising:
a board assembly including a multi-layer substrate having at least a first supporting layer and a second layer on which an image is formed on a top surface thereof, said second layer being adapted to be mounted to said supporting layer, and said first layer being of a material capable of retaining pin-type implements impaled therein,
a frame for displaying the image carried by the top surface of the second layer of the substrate, and
at least one other layer, exhibiting a second image different from the first image, adapted to be mounted atop the first layer of the substrate for selectively changing the image visible to a viewer.

2. The pin board of claim 1, wherein said at least one other layer includes means for mounting it on a surface of said substrate opposite the surface on which said second layer is mounted.

3. The pin board of claim 2, wherein said second layer carries adhesive means for mounting said second layer to said first layer.

4. The pin board of claim 2, wherein said means for mounting comprises adhesive means.

5. An image display kit, comprising:
a multi-layer substrate having a first supporting layer and a second layer mounted to said first layer and on which an image is formed on a top surface thereof, and
at least one other layer, exhibiting a second image different from the first image, adapted to be secured directly atop the first layer of the substrate for selectively changing the image visible to a viewer.

6. The image display kit of claim 5, wherein said second layer is first removed before securing said other layer to said first supporting layer.

7. The image display kit of claim 5, wherein said at least one other layer is applied directly atop said second layer in a manner that it is the image visible to a viewer.

8. The image display kit of claim 5, wherein said supporting layer is rigid, and said at least one other layer comprises images chosen from a set of distinct images different from said first image.

9. An image displaying pin board, comprising:
a multi-layer substrate having a first supporting layer and a first display layer on which an image has been formed on a top surface thereof, said second layer being removably mounted to said first supporting layer with said image facing away from said first layer and being observable to a viewer, and
at least one other display layer, exhibiting a second image different from the first image, adapted to be mounted atop the first supporting layer of the substrate in place of the second layer for selectively changing the image visible to said viewer.

10. The image display pin board of claim 9, wherein said image on said display layers are applied through a sublimation printing process.

11. The image display pin board of claim 9 wherein said first display layer is detachably secured to said first supporting layer.

12. The image display pin board of claim 9, wherein said first supporting layer includes adhesive, and said first display layer is adhesively secured to said first supporting layer.

13. The image display pin board of claim 9, wherein said first supporting layer includes releasable attachment means on the surface which adjoins the second layer.
